(19) United States
(12) Patent Application Publication
(10) Pub. No.: US 2005/0057541 A1
(43) Pub. Date: Mar. 17, 2005

(54) Display panel having symmetric structure and display device employing the same

(76) Inventor: Sang-Duk Lee, Yongin-si (KR)

Correspondence Address: CANTOR COLBURN LLP, 55 Griffin Road South, Bloomfield, CT, 06002, US

(21) Appl. No.: 10/871,862

(22) Filed: Jun. 19, 2004

(30) Foreign Application Priority Data
Sep. 3, 2003 (KR) 2003-61318

(51) Int. Cl. G09G 3/36

(52) U.S. Cl. 345/204

(57) ABSTRACT

A display unit includes a printed circuit board to provide a driving signal, a display panel having a thin film transistor substrate and a color filter substrate to display images at a display region in response to the driving signal, and a tape carrier package to provide a electrical connection between the printed circuit board and the thin film transistor, which is disposed at a bonding region of the thin film transistor. The thin film transistor substrate and the color filter substrate each have first and second side peripheral regions disposed at opposite sides, respectively, of the display region, and are substantially symmetric with respect to a center of the display panel. An image display device includes the display unit and a receiving container to receive the display unit, in which the receiving container has first and second sidewalls to support the first and second side peripheral regions, respectively, and the first and second sidewalls have holes at selected positions each to be engaged with a screw.

### BACKGROUND OF THE INVENTION

1. Field of the Invention

The present invention relates to image display devices, and more particularly, to a display panel having a symmetric structure and a display device employing the same so that the display device has a center substantially coincident with that of its display region.

2. Description of the Related Art

Devices processing image data to display images have been developed to have various shapes and functions as well as to improve its processing speed. In an image data processing device, image data is processed as electric signals and displayed as images by means of a display device.

Of the various types of display devices, liquid crystal display devices are widely used and in high demand for its merits such as light weight, thin thickness, low power consumption, etc. Generally, a liquid crystal display device includes a display unit for displaying images and a backlight unit for providing light to the display unit.

FIG. 1 is a schematic diagram illustrating a display unit of a conventional display device. Referring to FIG. 1, the display unit 100 includes a liquid crystal display panel 110 having a thin film transistor substrate 112 and a color filter substrate 114, which are disposed facing each other. A liquid crystal layer (not shown) is interposed between the thin film transistor 112 and the color filter substrate 114.

The display unit 100 further includes a data printed circuit board 120, a gate printed circuit board 130, a data tape carrier package 140, and a gate tape carrier package 150. The data printed circuit board 120 outputs a driving signal for driving the liquid crystal display panel 110. The data tape carrier package 140 electrically connects the data printed circuit board 120 to the thin film transistor substrate 112 of the liquid crystal display panel 110. The gate tape carrier package 150 electrically connects the gate printed circuit board 130 to the thin film transistor substrate 112 of the liquid crystal display panel 110.

The data tape carrier package 140 is a flexible printed circuit board including a data driving chip 142 for providing data signals to data lines (not shown) of the thin film transistor substrate 112. The gate tape carrier package 150 is a flexible printed circuit board including a gate driving chip 152 for providing gate signals to gate lines (not shown) of the thin film transistor substrate 112. The gate lines and the data lines are formed on the thin film transistor substrate 112, such that the gate and data lines are substantially perpendicular to each other.

FIG. 2 is a cross-sectional view of a conventional liquid crystal display device having the display unit in FIG. 1. Referring to FIG. 2, a receiving container 210 supports the liquid crystal display panel 110 received therein. The receiving container 210 also receives a lamp unit (not shown) for generating light, a light guide plate 220 for adjusting a path of the light generated from the lamp unit, and optical sheets for enhancing optical characteristics of the light exiting the light guide plate 220. The gate tape carrier package 150 is bent such that the gate printed circuit board 130 is disposed on a backside of the receiving container 210.

In other developments, the gate printed circuit board 130 and the data printed circuit board 120 are designed to be integrated as a unified printed circuit board, so that the gate printed circuit board 130 is not necessary. An example of the unified printed circuit board is disclosed in commonly owned Korean patent No. 0304261.

In the conventional display panel employing the unified printed circuit board, however, the gate tape carrier package 150 is still required separate from the data tape carrier package 140. As shown in FIGS. 1 and 2, the conventional liquid crystal display device 1000 requires an additional bonding region for connecting the gate tape carrier package 150 to the thin film transistor substrate 112. As a result, a size of the liquid crystal display device increases. Further, since the bonding region is formed at one side of the display panel, the conventional liquid crystal display device has an asymmetric structure. That is, a center of the liquid crystal display device is not coincident with a center of the display region on which images are displayed, and a position of a hole for combining the receiving container 210 and a case (not shown) is limited due to the gate tape carrier package 150.

### SUMMARY OF THE INVENTION

The above mentioned and other drawbacks and deficiencies of the prior art are overcome or alleviated by an image display device according to the present invention. In one embodiment, a display unit for displaying images includes a printed circuit board to provide a driving signal, a display panel to display images in response to the driving signal, and a tape carrier package to provide a electrical connection between the printed circuit board and the display panel, in which the display panel is substantially symmetric with respect to a virtual central line of the display panel, and the virtual central line is perpendicular to a longitudinal direction of the printed circuit board. The display panel may also include a bonding region at which the tape carrier package is connected to the display panel. The display panel may include a display region at which images are displayed, and a peripheral region disposed around the display region, in which the peripheral region includes first and second side peripheral regions disposed at opposite sides, respectively, of the display panel, and the peripheral region is symmetric with respect to the virtual central line of the display panel. The first and second side peripheral regions may have a substantially identical width.

The display panel may further include a thin film transistor substrate having thin film transistors arranged in a matrix form at the display region, a color filter substrate having color filters at the display region, and a liquid crystal layer disposed between the thin film transistor substrate and the color filter substrate at the display region, in which the thin film transistor substrate and the color filter substrate have the first and second side peripheral regions at opposite sides, respectively, of the thin film transistor substrate and the color filter substrate.

In another embodiment, a display device for displaying images includes the display unit as describe above, and a receiving container to receive the display unit, which has first and second sidewalls to support the first and second side peripheral regions, respectively. The first and second sidewalls of the receiving container have holes at selected positions, and a screw is engaged into each of the holes to combine the receiving container in the display device. The display device may also include a top chassis to hold the display panel in the receiving container, which has openings corresponding to the holes, respectively, of the first and second sidewalls so that a screw is engaged into each of the holes through corresponding one of the openings.

These and other objects, features and advantages of the present invention will become apparent from the following detailed description of illustrative embodiments thereof, which is to be read in connection with the accompanying drawings.

### BRIEF DESCRIPTION OF THE DRAWINGS

This disclosure will present in detail the following description of exemplary embodiments with reference to the following figures wherein:

FIG. 1 is a schematic diagram illustrating a conventional display unit;

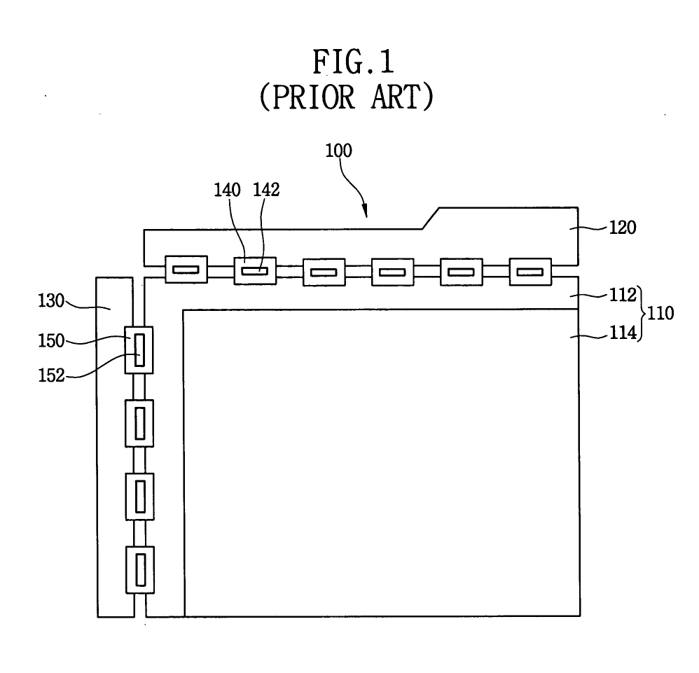

FIG. 2 is a cross-sectional view of a conventional liquid crystal display device having the display unit in FIG. 1;

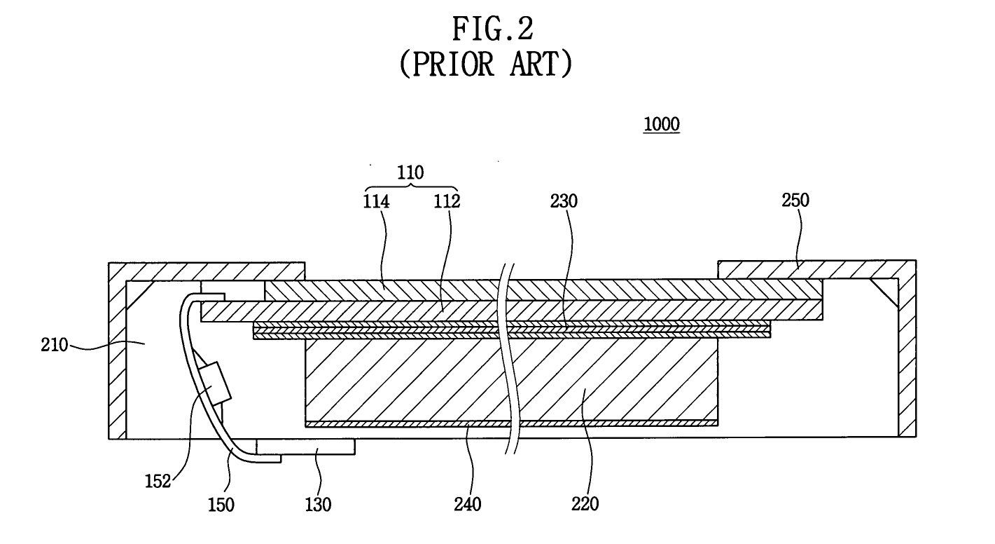

FIG. 3 is an exploded perspective view showing a liquid crystal display device according to an exemplary embodiment of the present invention;

FIG. 4 is a schematic diagram illustrating the display unit in FIG. 3;

FIG. 5 is a cross-sectional view of the display unit taken along line A-A′ in FIG. 4;

FIG. 6 is a schematic diagram illustrating the thin film transistor substrate in FIG. 4;

FIG. 7 is a block diagram illustrating the gate driving circuit in FIG. 6;

FIG. 8 is a perspective view of the receiving container in FIG. 3;

FIG. 9 is a cross-sectional view of the container taken along line B-B′ in FIG. 8;

FIG. 10 is a cross-sectional view of the liquid crystal display device taken along line C-C′ in FIG. 3; and

FIG. 11 is a perspective view of a portion of the receiving container in FIG. 10.

### DETAILED DESCRIPTION OF THE INVENTION

Detailed illustrative embodiments of the present invention are disclosed herein. However, specific structural and functional details disclosed herein are merely representative for purposes of describing exemplary embodiments of the present invention.

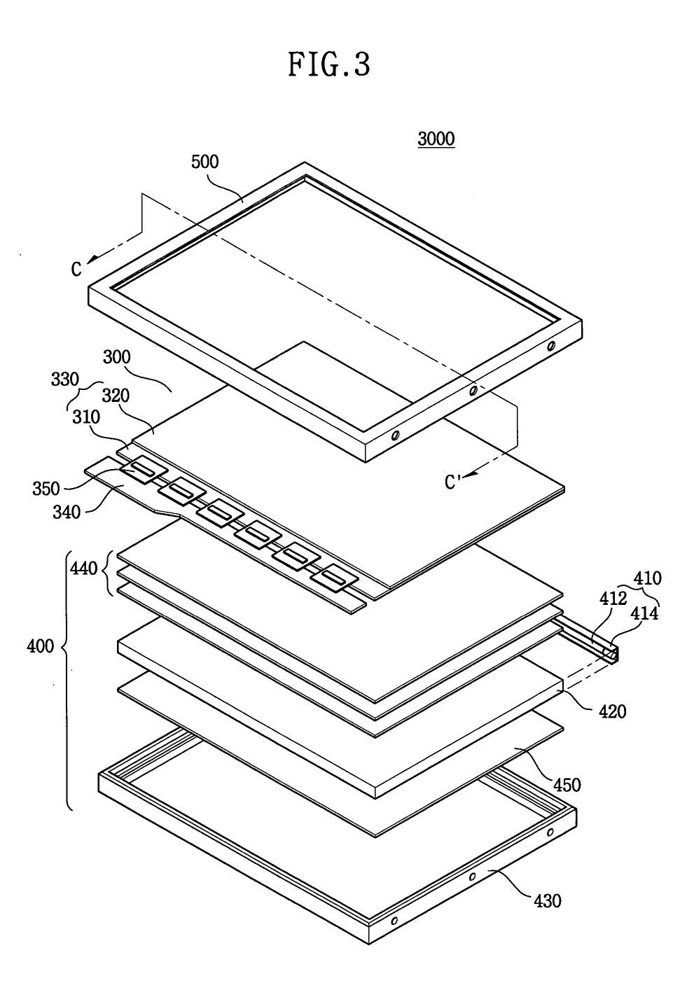

FIG. 3 is an exploded perspective view of a liquid crystal display device according to an exemplary embodiment of the present invention. Referring to FIG. 3, the liquid crystal display device 3000 includes a display unit 300, a backlight assembly 400, and a top chassis 500. The backlight assembly 400 provides light to the display unit 300. The top chassis 500 securely holds the display unit 300 onto the backlight assembly 400.

The display unit 300 includes a liquid crystal display panel 330 for displaying images, a printed circuit board 340 for providing a driving signal to the liquid crystal display panel 330, and a tape carrier package 350 for electrically connecting the printed circuit board 340 to the liquid crystal display panel 330.

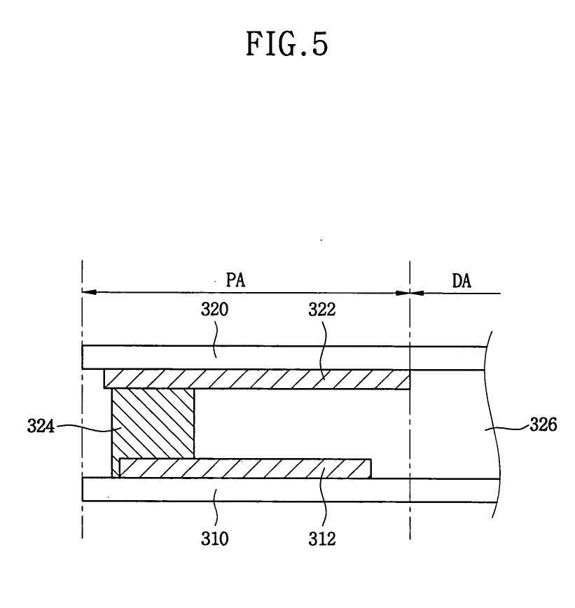

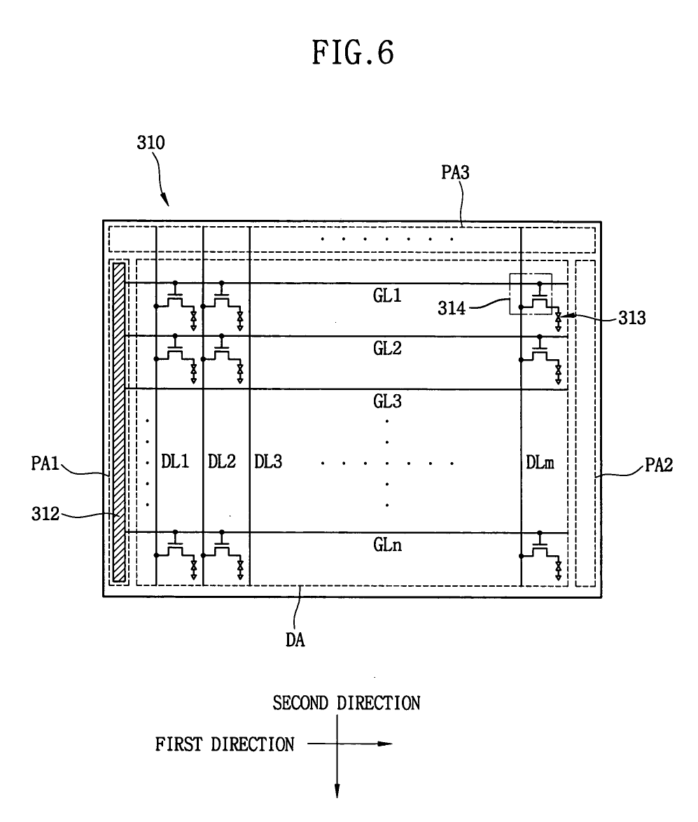

The liquid crystal display panel 330 includes a thin film transistor substrate 310, a color filter substrate 320 facing the thin film transistor substrate 310, and a liquid crystal layer (referring to FIG. 5) interposed between the thin film transistor substrate 310 and the color filter substrate 320. The thin film transistor substrate 310 includes a glass substrate on which thin film transistors (referring to FIG. 6) are arranged in a matrix from. Each of the thin film transistors has a gate electrode that is electrically connected to a gate line, a source electrode that is electrically connected to a data line, and a drain electrode that is electrically connected to a pixel electrode (referring to FIG. 6). The pixel electrode comprises a material that is electrically conductive and optically transparent. The color filter substrate 320 includes a red color filter (not shown), a green color filter (not shown) and a blue color filter (not shown) and a common electrode (not shown) formed on the color filters.

The backlight assembly 400 is disposed under the display unit 300 to provide uniform light to the display unit 300. The backlight assembly 400 includes a lamp unit 410 for generating light, a light guide plate 420 for adjusting a path of the light generated from the lamp unit 410, and a receiving container 430 for receiving the lamp unit 410 and the light guide plate 420.

The lamp unit 410 includes at least one lamp 412, and a lamp reflector 414 for reflecting the light generated from the lamp 412 toward the light guide plate 420. The lamp unit 410 is disposed at one side of the light guide plate 420. The light guide plate 420 transforms one-dimensional light generated from the lamp unit 410 into two-dimensional light. Reflection patterns (not shown) for uniformizing the light may be formed on a bottom surface of the light guide plate 420.

The receiving container 430 includes a bottom plate and four sidewalls respectively extended from the four edges of the bottom plate. The bottom plate and the sidewalls form a receiving space for receiving the lamp unit 410 and the light guide plate 420.

The backlight assembly 400 may further include optical sheets 440 for enhancing optical characteristics, and a reflection sheet 450 for reflecting light leaked from the light guide plate 420 toward the light guide plate 420. The optical sheets 440 include a diffusion sheet for diffusing the light, and at least one prism sheet for condensing the light, so that the optical sheets 440 enhance uniformity and luminance of the light.

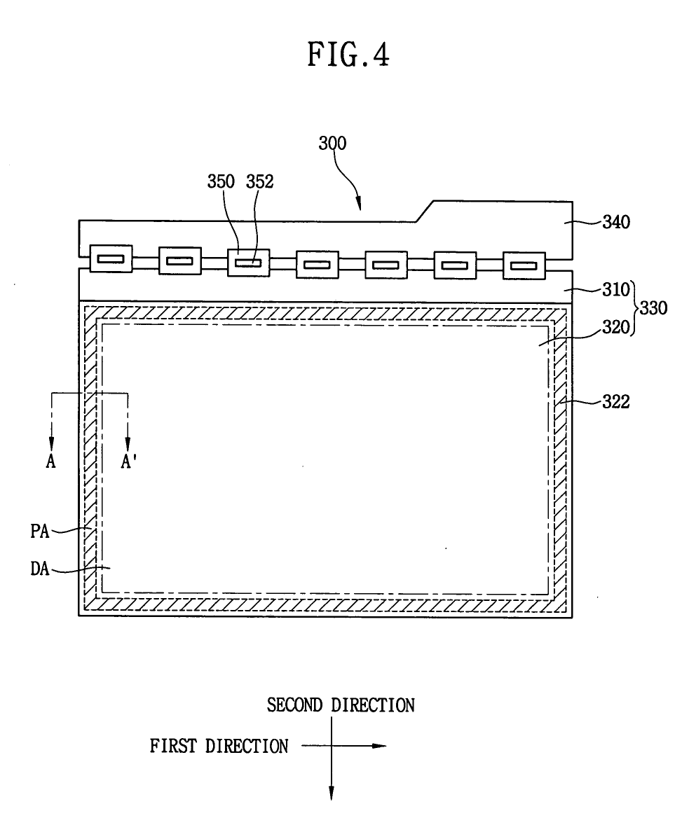

FIG. 4 is a schematic diagram illustrating the display unit in FIG. 3, and FIG. 5 is a cross-sectional view of the display unit taken along line A-A′ in FIG. 4. Referring to FIGS. 4 and 5, the display unit 300 includes a thin film transistor substrate 310, a color filter substrate 320, and a liquid crystal layer 326 interposed between the thin film transistor substrate 310 and the color filter substrate 320. A sealing member 324 disposed between the thin film transistor substrate 310 and the color filter substrate 320 confines liquid crystal material to form the liquid crystal layer 326.

The display unit 300 includes a printed circuit board 340 and a tape carrier package 350. The printed circuit board 340 outputs a driving signal for driving the liquid crystal display panel 330. The tape carrier package 350 electrically connects the printed circuit board 340 to the liquid crystal display panel 330. A data driving chip 352 for providing driving signals to data lines (not shown) of the thin film transistor substrate 310 is formed on the tape carrier package 350.

In detail, the color filter substrate 320 has the substantially same length as that of the thin film transistor substrate 310 in the first direction as indicated in FIG. 4. In contrast, the color filter substrate 320 has a shorter length than that of the thin film transistor substrate 310 in the second direction as indicated in FIG. 4. When the display unit 300 is assembled, a bonding region is formed owing to the length difference between the thin film transistor substrate 310 and the color filter substrate 320. In the bonding region, the tape carrier package 350 and the thin film transistor substrate 310 are connected with each other.

The color filter substrate 320 includes a light blocking layer 322 disposed at a peripheral region PA surrounding a display region DA at which images are displayed. In this embodiment, two side peripheral regions at the left and right sides of the display panel 330 with respect to the bonding area have a substantially identical width. Thus, the display panel 330 has a structure substantially symmetric with respect to its virtual central line which is perpendicular to a longitudinal direction of the bonding region. Accordingly, the center of the liquid crystal display device is substantially coincident with the center of the display region at which images are displayed.

A gate driving circuit 312 is formed on the thin film transistor substrate 310. The gate driving circuit 312 is formed at the peripheral region PA. The gate driving circuit 312, for example, overlaps with the light blocking layer 322. The gate driving circuit 312, for example, is formed at one of the two side peripheral regions at either left or light side of the display unit.

FIG. 6 is a schematic view of thin film transistor substrate in FIG. 4. Referring to FIG. 6, the thin film transistor substrate 310 include a display region DA at which images are displayed, and a peripheral region PA disposed around the display region DA. In this embodiment, the peripheral region PA includes two side peripheral regions PA1 and PA2, and a third peripheral region PA3. A first side peripheral region PA1 is disposed at the left side of the display region DA, a second side peripheral region PA2 is disposed at the right side of the display region DA. The third peripheral region PA3 is disposed at an upper side of the display region DA adjacent to the bonding region at which the tape carrier package is connected with the thin film transistor substrate. The tape carrier package is attached on the third peripheral region PA3 through a bonding procedure.

The display region DA includes a plurality of pixels arranged in a matrix form. Each of the pixels includes a thin film transistor 314 and a pixel electrode 313. The thin film transistor 314 is electrically connected to a data line DA extended in the first direction as indicated in FIG. 6, and a gate line GL is extended in the second direction as indicated in FIG. 6, which is substantially perpendicular to the first direction. The pixel electrode 313 is electrically connected to the thin film transistor 314.

The number (or count) of the pixels determines a resolution of the display unit. For example, when the number of the pixels is ‘m×n’, the resolution is referred to be ‘m×n’, and the thin film transistor substrate 310 includes ‘m’ data lines DL1 to DLm and ‘n’ gate lines GL1 to GLn.

The first and second side peripheral regions PA1 and PA2 have a substantially identical width. A gate driving circuit 312 is formed at one of the first and second side peripheral regions PA1 and PA2. The gate driving circuit 312 may be formed in the process of forming the pixels. In other words, the gate driving circuit 312 and the pixels may be formed simultaneously. In the embodiment of FIG. 6, the gate driving circuit 312 is formed only at the first side peripheral region PA1. However, the gate driving circuit 312 may be formed at the second side peripheral region PA2, or both the first and second peripheral regions PA1 and PA2. The gate driving circuit 132 includes a shift register and a plurality of signal wirings.

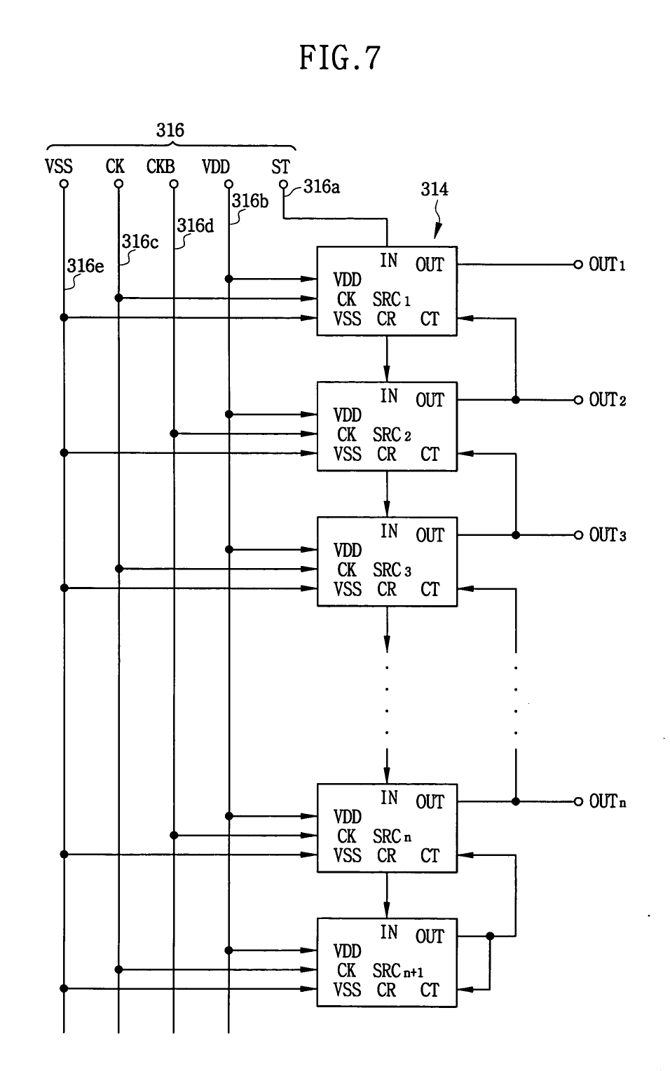

FIG. 7 is a block diagram illustrating the gate driving circuit in FIG. 6. Referring to FIG. 7, a shift register 314 includes a plurality of stages SRC1 to SRCn+1 arranged in sequence. In detail, the shift register 314 includes ‘n’ driving stages SRC1 to SRCn and one dummy stage SRCn+1, wherein ‘n’ is an even number. The driving stages SRC1 to SRCn generate in sequence ‘n’ gate driving signals OUT₁ to OUTₙ to ‘n’ gate lines, respectively. An output terminal of each of the driving stages SRC1 to SRCn is electrically connected to a control terminal CT of a previous stage. A carry terminal CR of each of the driving stages SRC1 to SRCn is electrically connected to an input terminal IN of a next stage. Exceptionally, the input terminal IN of the first driving stage SRC1 receives a scan start signal ST instead of an output signal from a previous stage.

The input terminal IN of the dummy stage SRCn+1 is electrically connected to the carry terminal CR of the n-th driving stage SRCn, and an output terminal OUT is electrically connected to a control terminal CT of the n-th stage SRCn. Thus, the dummy stage SRCn+1 allows the n-th driving stage SRCn to operate normally.

Further, the output terminal OUT of the dummy stage SRCn+1 is electrically connected to the control terminal CT of the dummy stage SRCn+1, so that the dummy stage SRCn+1 is controlled by output signal outputted from the dummy stage SRCn+1 itself.

Wirings 316 for transferring signals to the shift register 314 are formed at a circumference of the shift register 314. The wirings 316 include a scan start signal wiring 316a, a driving voltage wiring 316b, first and second clock signal wirings 316c and 316d, and ground wiring 316e.

The scan start signal wiring 316a applies the scan start signal ST from an external device to the input terminal IN of the first driving stage SRC1. For example, the scan start signal is a pulse signal synchronized with a vertical synchronization signal provided from an external graphic controller (not shown). The driving voltage wiring 316b is electrically connected to the driving stages SRC1 to SRCn and the dummy stage SRCn+1 to apply a driving voltage VDD to the driving stages SRC1 to SRCn and the dummy stage SRCn+1. The ground wiring 315e is electrically connected to the driving stages SRC1 to SRCn and the dummy stage SRCn+1 to apply a ground voltage VSS to the driving stages SRC1 to SRCn and the dummy stage SRCn+1.

The first clock signal wiring 316c is electrically connected to the odd numbered driving stages SRC1, SRC3, SRC5, . . . , SRCn−1, and the dummy stage SRCn+1 to apply a first clock signal CK to the odd numbered driving stages SRC1, SRC3, SRC5, . . . , SRCn−1, and the dummy stage SRCn+1. The second clock signal wiring 316d is electrically connected to the even numbered driving stages SRC2, SRC4, SRC6, . . . , SRCn to apply a second clock signal CKB to the even numbered driving stages SRC2, SRC4, SRC6, . . . , SRCn. The second clock signal CKB, for example, has a phase opposite to that of the first clock signal CK.

The output signals OUT1 to OUTn with a high level are outputted in sequence, so that the gate lines GL1 to GLn corresponding to the output signals OUT1 to OUTn are selected in sequence.

As described above, according to the display unit 300 in FIGS. 4 to 7, the first and second side peripheral regions PA1 and PA2 disposed at the left and right sides, respectively, have the substantially same width. Accordingly, the center of the liquid crystal display device is coincident with the center of the display region at which images are displayed. Further, the gate driving circuit 312 is formed on the first side peripheral region PA1, so that the conventional gate printed circuit board and the gate tape carrier package are not required in the present invention. Also, the bonding region for connecting the liquid crystal display panel 330 and the gate tape carrier package is not necessary, so that the size of the liquid crystal display panel 330 is reduced.

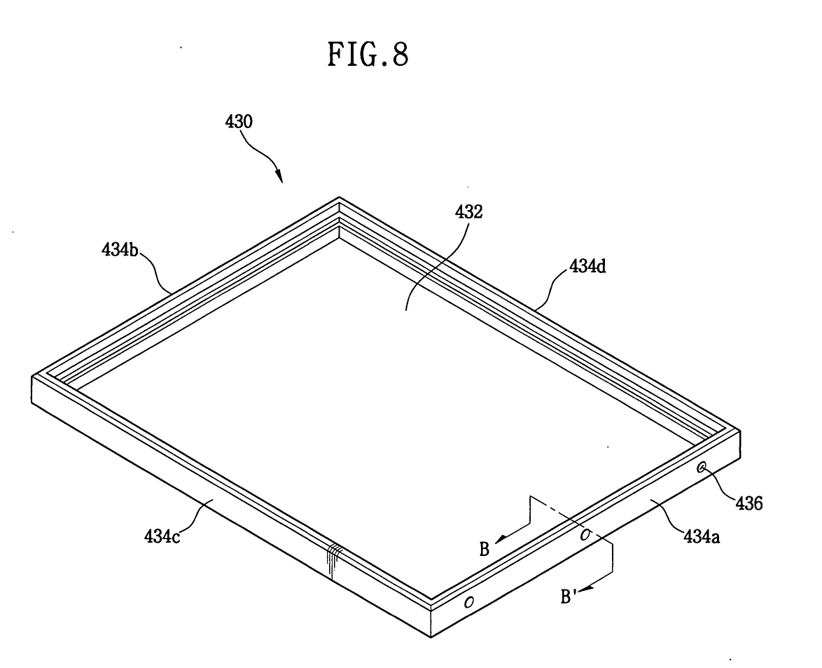

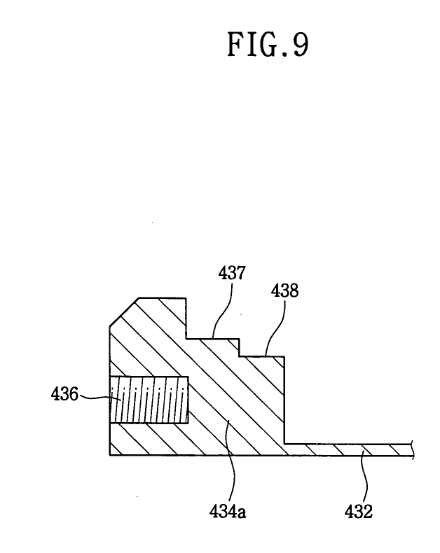

FIG. 8 is a perspective view of the receiving container in FIG. 3, and FIG. 9 is a cross-sectional view of the receiving container taken along line B-B′ in FIG. 8. Referring to FIGS. 8 and 9, a receiving container 430 includes a bottom plate 432 and first to fourth sidewalls 434a, 434b, 434c and 434d respectively extended from the edges of the bottom plate 432. The first and second sidewalls 434a and 434b facing each other have a substantially identical thickness. The first sidewall 434a supports the first side peripheral region PA1 of the liquid crystal display panel 330, and the second sidewall 434b supports the second side peripheral region PA2 of the liquid crystal display panel 330.

Holes 436 are formed at the first and second sidewalls 434a and 434b. The receiving container 430 is combined with a case (not shown) to protect the liquid crystal display device 3000 by engaging screws into the holes 436. An outer surface of the first and second sidewalls 434a and 434b are recessed to form the holes 436. Since the display unit 300 of the present invention has neither gate printed circuit board nor gate tape carrier package, the holes 436 may be formed at any position of the sidewalls, which otherwise would be limited to certain positions in the conventional liquid crystal display device.

The first to fourth sidewalls 434a, 434b, 434c and 434d each have a first step 437 for supporting the liquid crystal display panel 330, and a second step 438 for supporting the optical sheets 440. The first and second steps 437 and 438 are formed at the inner face of the respective sidewalls 434a to 434d. The receiving container 430 receives in sequence the light guide plate 420 disposed on the bottom plate 432, the optical sheets 440 disposed on the light guide plate 425 and the second step 438 of the sidewalls, and the display panel 330 disposed on the optical sheets 440 and the first step 437 of the sidewalls. The edge regions of the display panel 330 and the optical sheets 440 are placed on the first and second steps 437 and 438, respectively, of the sidewalls 434a to 434d.

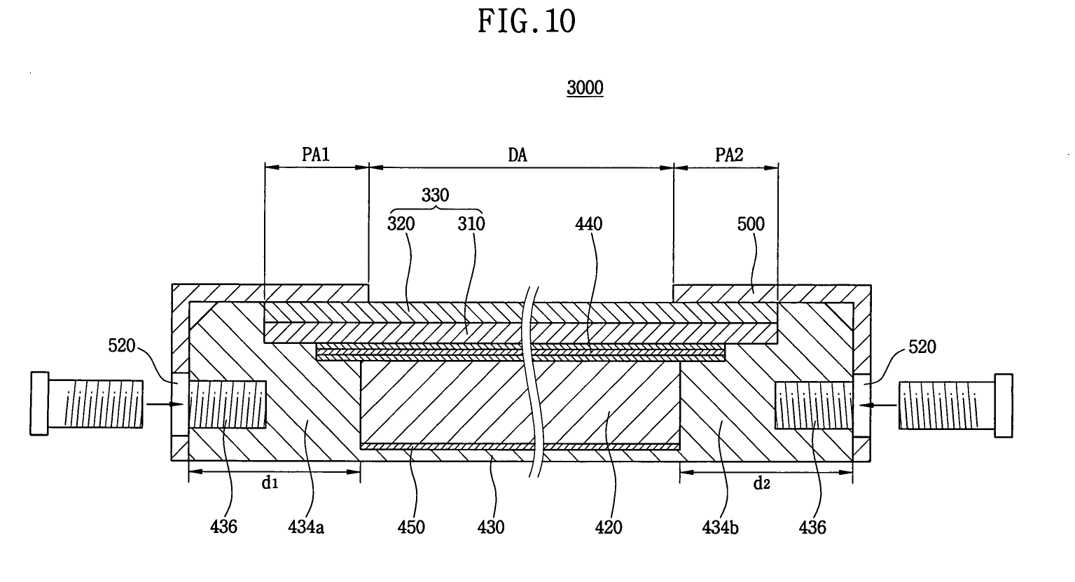

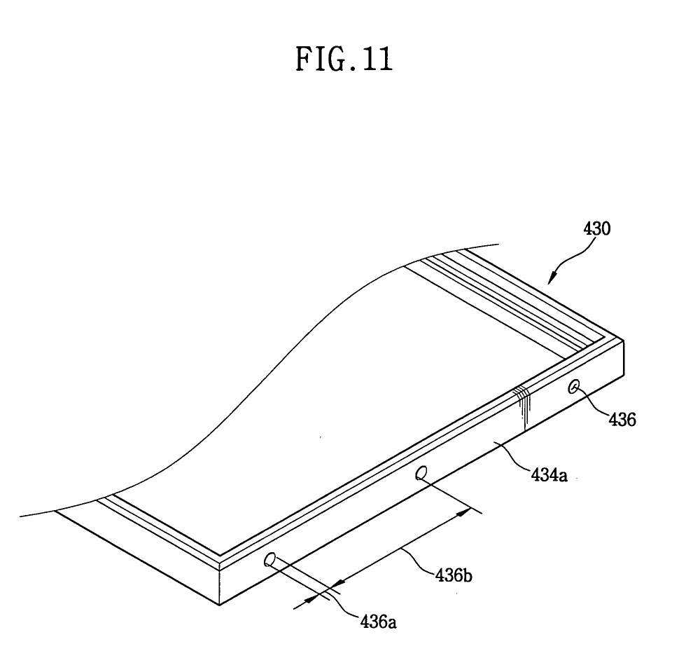

FIG. 10 is a cross-sectional view of the liquid crystal display device taken along line C-C′ in FIG. 3, and FIG. 11 is a perspective view showing a portion of the receiving container in FIG. 10. Referring to FIGS. 10 and 11, the receiving container 430 receives the reflection sheet 450, the optical sheets 440 and the liquid crystal display panel 330 in sequence. The top chassis 500 is combined with the receiving container 430 to prevent the liquid crystal display panel 330 from being separated from the receiving container 430.

The liquid crystal display panel 330 includes the display region DA and the first and second side peripheral regions PA1 and PA2 disposed adjacent to the display region DA. The first and second side peripheral regions PA1 and PA2 have a substantially identical width. A gate driving circuit is formed on the first peripheral region PA1, so that the size of the liquid crystal display panel 330 is reduced.

In this embodiment, the first sidewall 434a for supporting the first side peripheral region PA1 has a first thickness d₁, and the second sidewall 434b for supporting the second peripheral region PA2 has a second thickness d₂, and the first and second thicknesses d₁ and d₂ are substantially equal to each other.

Accordingly, the liquid crystal display panel 330 has a virtual centerline substantially coincident with that of the liquid crystal display device 300. Further, the liquid crystal display panel has a reduced size, so that the size of the liquid crystal display device 3000 is also reduced.

Holes 436 for combining the receiving container 430 and the case are formed at the first and second sidewalls 434a and 434b, and the top chassis 500 includes openings 520 corresponding to the holes 436. The receiving container 430 and the top chassis 500 are combined by engaging the screws into the openings 520 and the holes 436. As shown in FIG. 11, the holes 436 formed at the first and second sidewalls 434a and 434b each have a predetermined diameter 436a corresponding to that the screws. Although there is no limitation in the positions of the holes 436, the holes 436 may be formed such that the distance between the adjacent holes 436 is larger than the diameter 436b.

Having described the exemplary embodiments of the display unit and the display device employing the same according to the present invention, modifications and variations can be readily made by those skilled in the art in light of the above teachings. It is therefore to be understood that, within the scope of the appended claims, the present invention can be practiced in a manner other than as specifically described herein.

1. A display unit for displaying images, comprising:
a printed circuit board to provide a driving signal;
a display panel to display images in response to the driving signal; and
a tape carrier package to provide a electrical connection between the printed circuit board and the display panel,
wherein the display panel is substantially symmetric with respect to a virtual central line of the display panel, the virtual central line being perpendicular to a longitudinal direction of the printed circuit board.

2. The display unit of claim 1, wherein the display panel includes a bonding region at which the tape carrier package is connected to the display panel.

3. The display unit of claim 2, wherein the display panel includes:
a display region at which images are displayed; and
a peripheral region disposed around the display region, the peripheral region including first and second side peripheral regions disposed at opposite sides, respectively, of the display panel,
wherein the peripheral region is symmetric with respect to the virtual central line of the display panel.

4. The display unit of claim 3, wherein the bonding region is disposed in a first direction and the first and second peripheral regions are disposed in a second direction parallel to each other, the first and second directions being substantially perpendicular to each other.

5. The display unit of claim 3, wherein the first and second side peripheral regions have a substantially identical width.

6. The display unit of claim 3, wherein the display panel includes a gate driving circuit providing a gate driving signal to gate lines in the display panel, the gate driving circuit being disposed at one of the first and second side peripheral regions.

7. The display unit of claim 3, wherein the display panel includes a gate driving circuit providing a gate driving signal to gate lines in the display panel, the gate driving circuit being disposed at both the first and second side peripheral regions.

8. The display unit of claim 3, wherein the display panel further includes:
a thin film transistor substrate having thin film transistors arranged in a matrix form at the display region;
a color filter substrate having color filters at the display region; and
a liquid crystal layer disposed between the thin film transistor substrate and the color filter substrate at the display region,
wherein the thin film transistor substrate and the color filter substrate have the first and second side peripheral regions at opposite sides, respectively, of the thin film transistor substrate and the color filter substrate.

9. The display unit of claim 8, wherein the bonding region is formed at an upper side of the thin film transistor substrate, the upper side being disposed between the opposite sides at which the first and second side peripheral regions are respectively disposed.

10. The display unit of claim 9, wherein the bonding region is disposed in a first direction and the first and second peripheral regions are disposed in a second direction parallel to each other, the first and second directions being substantially perpendicular to each other, the thin film transistor substrate and the color filter substrate having a substantially identical length in the first direction.

11. The display unit of claim 8, wherein the display panel further includes:
a gate driving circuit to provide a gate driving signal to gate lines in the thin film transistor substrate, the gate driving circuit being formed on the thin film transistor substrate at one of the first and second side peripheral regions; and
a light blocking layer disposed on the color filter substrate at the first and second side peripheral regions, the light blocking layer facing the gate driving circuit.

12. A display device for displaying images, comprising:
a display unit including:
a printed circuit board to provide a driving signal;
a display panel having a thin film transistor substrate and a color filter substrate to display images at a display region in response to the driving signal; and
a tape carrier package to provide a electrical connection between the printed circuit board and the thin film transistor, the tape carrier package being disposed at a bonding region of the thin film transistor,
wherein the thin film transistor substrate and the color filter substrate have first and second side peripheral regions disposed at opposite sides, respectively, of the display region, and the thin film transistor substrate and the color filter substrate are substantially symmetric with respect to a center of the display panel; and
a receiving container to receive the display unit, the receiving container having first and second sidewalls to support the first and second side peripheral regions, respectively.

13. The display device of claim 12, wherein the first and second sidewalls of the receiving container have holes at selected positions, a screw being engaged into each of the holes to combine the receiving container in the display device.

14. The display device of claim 13, further including a top chassis to hold the display panel in the receiving container, the top chassis including openings corresponding to the holes, respectively, of the first and second sidewalls so that a screw is engaged into each of the holes through corresponding one of the openings.

15. The display device of claim 13, wherein the first and second sidewalls of the receiving container have a substantially identical thickness.

16. The display device of claim 12, wherein the thin film transistor substrate and the color filter substrate have a substantially identical length in a direction parallel to a longitudinal direction of the bonding region.

17. The display device of claim 16, wherein the first and second side peripheral regions have a substantially identical width.

18. The display device of claim 17, wherein the thin film transistor substrate includes a gate driving circuit providing a gate driving signal to gate lines in the display panel, the gate driving circuit being disposed at one of the first and second side peripheral regions.

19. The display device of claim 18, wherein the display panel further includes a light blocking layer disposed on the color filter substrate at the first and second side peripheral regions, the light blocking layer facing the gate driving circuit.
